(19) United States
(12) Patent Application Publication
(10) Pub. No.: US 2018/0141205 A1
(43) Pub. Date: May 24, 2018

(54) Utensil shelf

(71) Applicant: Nathaniel Mathis, District Heights, MD (US)

(72) Inventor: Nathaniel Mathis, District Heights, MD (US)

(21) Appl. No.: 15/530,558

(22) Filed: Jan. 30, 2017

Related U.S. Application Data
(60) Provisional application No. 62/497,562, filed on Nov. 23, 2016.

(51) Int. Cl. B25H 3/04; A47B 81/00; A47B 57/10; A47B 95/02; A47B 96/02

(52) U.S. Cl. CPC B25H 3/04; A47B 81/00; A47B 96/021; A47B 95/02; A47B 57/10

(57) ABSTRACT

The advantage of the Utensil Shelf is to be able to find your instruments, implements, or gadgets, when needed. The swivel base helps to rapidly find the instruments, implements, or gadgets.

The top of the structure has 21 openings/holes that can be used to store or to easily remove an instrument for use. The purpose of the Utensil Shelf is to store, organize, and make available space for your implements.

The Utensil Shelf is for anyone that uses some type of small instruments.

The Shelf is a revolving quadrilateral structure that has 4 sides with inserts that hold the removable shelves in place.

The inserts also help the shelves to slide in and out easily, as well as the uniquely designed handles that are attached to the removable shelves.

The removable shelves can be lowered or raised depending on the need for space.

The Utensil Shelf is a handy shelf that makes it easy to store, view, and retrieve quickly the implements needed at that time.

My invention came about in 1986. I misplaced a gadget and the idea for the Shelf was born.

The Utensil Shelf was designed for anyone that uses some type of small instruments. The Shelf is a revolving quadrilateral structure that has 4 sides with inserts that hold the removable shelves in place.

The inserts also help the shelves to slide in and out easily, as well as the uniquely designed handles that are attached to the removable shelves. The removable shelves can be lowered or raised depending on the need for space.

The top of the structure was designed with 21 openings/holes that can be used to store or to easily remove an instrument for use.

The purpose of the Utensil Shelf is to store, organize, and make available space for your implements.

Being able to find your implements will solve a lot of the problems. The advantage of the Utensil Shelf is to be able to find your instruments, implements, or gadgets, when needed. The swivel base helps to rapidly find the instruments, implements, or gadgets.

### BRIEF DESCRIPTION OF DRAWINGS

FIG. 1 Top view

FIG. 2 Side view

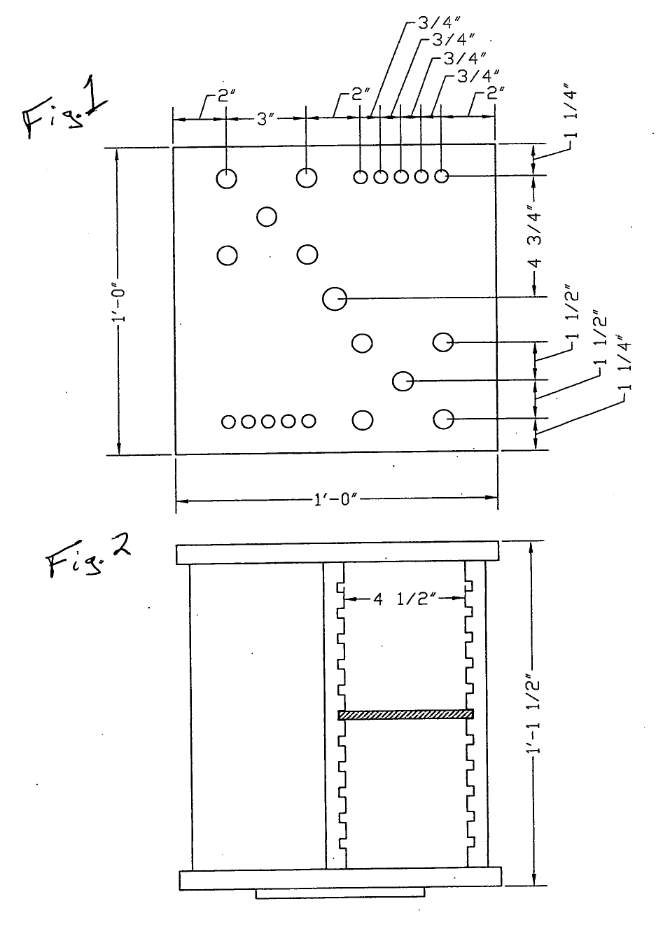

The Utensil Shelf is designed for instruments, implements, gadgets or (Tools of the trade) as shown and described,

1. The top shelf is flat and square-shaped consisting of four corners,
The 21 holes/openings are uniquely designed in a 2 X pattern for easy access to the instruments, implements, gadgets or (Tools of the trade),
The 2 X's pattern lines up from left corner to right corner with 1 hole in the center of the top,
Note: The X pattern is designed with 5 [symbol] holes in the shape of an X, The Utensil Shelf top shelf has 2 X's, The first X is located at the left upper corner and the second X is located at the right lower corner.

2. Removable shelves with easy grip handles,
The easy grip handles on the removable shelves can be used to take a shelf out, push a shelf in, move a shelf up or down or turn the complete Utensil Shelf around,
Multiple adjustable shelf levels,
The Shelf has 4 sides; each one of the 4 sections has slots or inserts that hold the Shelf in place so they can slide in and out smoothly.

3. The swivel/revolving base allows easy access to view each implement and retain it quickly,
The Utensil Shelf can be made of wood or plastic.
